(19) United States
(12) Patent Application Publication
(10) Pub. No.: US 2015/0327179 A1
(43) Pub. Date: Nov. 12, 2015

(54) PORTABLE TERMINAL DEVICE

(71) Applicant: SHARP KABUSHIKI KAISHA, Osaka-shi, Osaka (JP)

(72) Inventor: Shiroh TAKAHASHI, Osaka-shi (JP)

(73) Assignee: Sharp Kabushiki Kaisha, Osaka-shi, Osaka (JP)

(21) Appl. No.: 14/649,602

(22) PCT Filed: Feb. 17, 2014
(86) PCT No.: PCT/JP2014/053605

§ 371 Date: Jun. 4, 2015

(30) Foreign Application Priority Data
Feb. 26, 2013 (JP) 2013-035810

(51) Int. Cl. H04W 52/02; H04M 1/725

(52) U.S. Cl. CPC H04W 52/0258; H04M 1/72522

(57) ABSTRACT

A portable terminal device achieving suppressed power consumption without impairing convenience of a user is provided. A portable terminal device includes a storage portion for storing an application and a history of use of the application, a communication portion for communicating with an information communication device, and a control unit for controlling the portable terminal device. The control unit is configured to calculate a frequency of use of the application based on the history of use and prohibit communication by the application with the information communication device when the frequency of use is lower than a predetermined frequency of use.

### TECHNICAL FIELD

This invention relates to a portable terminal device controlling communication with an information communication device.

### BACKGROUND ART

Various proposals for a technique for suppressing power consumption in a portable telephone such as a smartphone have conventionally been made.

For example, Japanese Patent Laying-Open No. 2010-056700 (PTD 1) discloses a technique for “determining a state of operation of an application executed by a portable terminal based on a power consumption correlation value and quitting the application.”

### CITATION LIST

### Patent Document

PTD 1: Japanese Patent Laying-Open No. 2010-056700

### SUMMARY OF INVENTION

### Technical Problem

According to the invention described in PTD 1, however, even an application high in frequency of use by a user is forcibly quitted, which is inconvenient. Therefore, a technique allowing suppressed power consumption without impairing convenience of a user is required.

This disclosure was made to solve the problems as described above, and an object thereof is to provide a portable terminal device achieving suppressed power consumption without impairing convenience of a user.

### Solution to Problem

According to one embodiment, a portable terminal device includes a storage portion for storing an application and a history of use of the application, a communication portion for communicating with an information communication device, and a control unit for controlling the portable terminal device. The control unit is configured to calculate a frequency of use of the application based on the history of use and prohibit communication by the application with the information communication device when the frequency of use is lower than a predetermined frequency of use.

Preferably, the storage portion further stores an installation time at which the application was installed. The control unit is configured to calculate the frequency of use based on the history of use and a time when the application was installed.

Preferably, the control unit is configured to calculate the frequency of use of the application every certain time period.

Preferably, the control unit is configured to detect a signal for controlling the application and prohibit communication by the application with the information communication device when the signal is not detected for a certain time period.

Preferably, the portable terminal device further includes a display portion for displaying a screen for execution of the application. The control unit is configured to prohibit communication by the application with the information communication device when the screen for execution of the application is not displayed on the display portion.

In one aspect, power consumption can be suppressed without impairing convenience of a user.

### BRIEF DESCRIPTION OF DRAWINGS

FIG. 1 is a block diagram showing a specific example of a hardware configuration of a portable terminal device 100.

FIG. 2 is a block diagram showing a specific example of a functional configuration of portable terminal device 100.

FIG. 3 is a diagram representing an application use history DB 224 stored in a storage portion 220.

FIG. 4 is a diagram for illustrating a method of calculating a frequency of use of an application 222.

FIG. 5 is a flowchart representing a flow of operations of portable terminal device 100.

FIG. 6 is a flowchart representing a flow of operations of portable terminal device 100.

FIG. 7 is a flowchart representing a flow of operations of portable terminal device 100.

### DESCRIPTION OF EMBODIMENTS

The present embodiment will be described hereinafter with reference to the drawings. In the description below, the same elements and components have the same reference characters allotted. Their label and function are also identical. Therefore, detailed description thereof will not be repeated.

<Hardware Configuration>

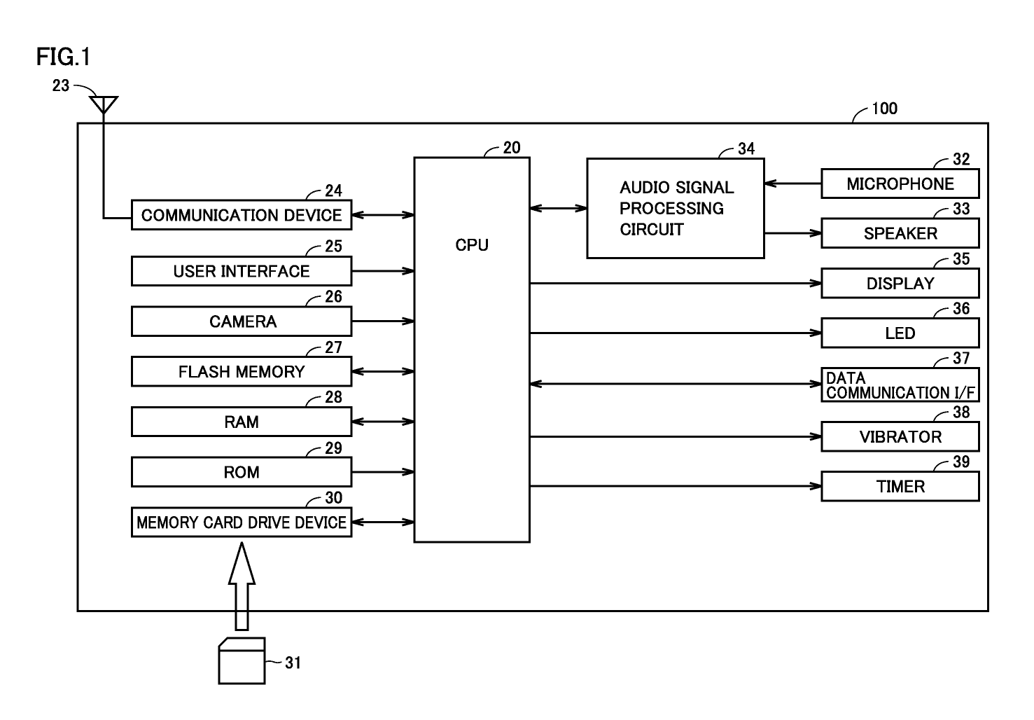

A hardware configuration of a portable terminal device 100 will be described with reference to FIG. 1. FIG. 1 is a block diagram showing a specific example of the hardware configuration of portable terminal device 100.

Portable terminal device 100 includes a central processing unit (CPU) 20, an antenna 23, a communication device 24, a user interface 25 such as an operation key, a camera 26, a flash memory 27, a random access memory (RAM) 28, a read only memory (ROM) 29, a memory card drive device 30, a microphone 32, a speaker 33, an audio signal processing circuit 34, a display 35, a light emitting diode (LED) 36, a data communication interface (I/F) 37, a vibrator 38, and a timer 39. A memory card 31 can be attached to memory card drive device 30.

Portable terminal device 100 is, for example, an information processing terminal such as a smartphone, a portable telephone, or a tablet terminal, having other communication instruments and a payment function.

Antenna 23 receives a signal issued by a base station. Antenna 23 transmits a signal for communicating with other communication devices through the base station. A signal received by antenna 23 is subjected to front end processing by communication device 24. A processed signal is sent to CPU 20.

CPU 20 performs processing for controlling an operation of portable terminal device 100 based on an instruction provided to portable terminal device 100. When antenna 23 of portable terminal device 100 receives a signal, CPU 20 performs processing defined in advance, based on a signal sent from communication device 24, and sends the processed signal to audio signal processing circuit 34. Audio signal processing circuit 34 performs processing defined in advance on the signal and sends the processed signal to speaker 33. Speaker 33 outputs voice and sound based on the signal.

Microphone 32 accepts utterance to portable terminal device 100 and sends a signal corresponding to uttered voice to audio signal processing circuit 34. Audio signal processing circuit 34 performs processing defined in advance for call based on the signal, and sends the processed signal to CPU 20. CPU 20 converts the signal to data for transmission, and sends the resultant data to communication device 24. Communication device 24 generates a signal for transmission from the data and sends the signal to antenna 23.

Flash memory 27 stores data sent from CPU 20. CPU 20 reads data stored in flash memory 27 and performs processing defined in advance with the data.

RAM 28 temporarily holds data generated by CPU 20. ROM 29 stores data or a program for having portable terminal device 100 perform a predetermined operation. CPU 20 reads the program or data from ROM 29 and controls an operation of portable terminal device 100.

Memory card drive device 30 reads data stored in memory card 31 and sends the read data to CPU 20. Memory card drive device 30 writes data output from CPU 20 into an empty area in memory card 31.

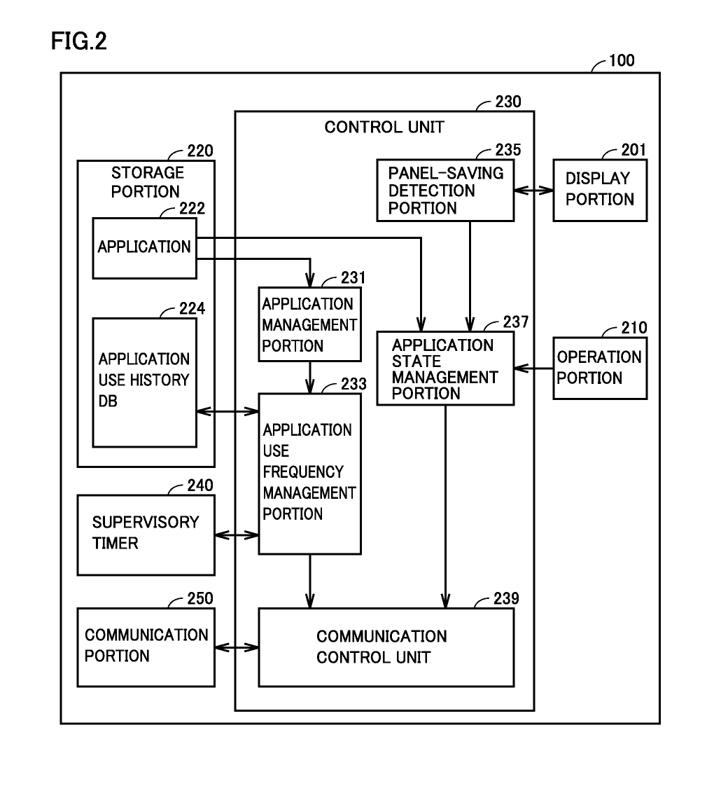

Audio signal processing circuit 34 performs signal processing for call as described above. Though CPU 20 and audio signal processing circuit 34 are shown as separate constituent features in the example shown in FIG. 2, CPU 20 and audio signal processing circuit 34 may be configured as being integrated in another aspect.

Display 35 is a display of a touch panel type, however, a mechanism for a touch panel is not particularly limited. Display 35 displays, based on data provided from CPU 20, an image defined by the data.

LED 36 implements a predetermined light emission operation based on a signal from CPU 20. Data communication I/F 37 accepts attachment of a cable for data communication. Data communication I/F 37 sends a signal output from CPU 20 to the cable. Alternatively, data communication I/F 37 sends data received through the cable to CPU 20.

Vibrator 38 performs an oscillation operation at a predetermined frequency based on a signal output from CPU 20.

Timer 39 counts time based on a signal output from CPU 20. Timer 39 inputs the counted time to CPU 20. Timer 39 inputs the current time to CPU 20.

<Functional Configuration>

A functional configuration of portable terminal device 100 will be described with reference to FIG. 2. FIG. 2 is a block diagram showing a specific example of the functional configuration of portable terminal device 100.

Portable terminal device 100 includes a display portion 201, an operation portion 210, a storage portion 220, a control unit 230, a supervisory timer 340, and a communication portion 250.

Storage portion 220 includes an application 222 and an application use history database (DB) 224.

Control unit 230 includes an application management portion 231, an application use frequency management portion 233, a panel-saving detection portion 235, an application state management portion 237, and a communication control unit 239.

Application management portion 231 detects an instruction to application 222. For example, the instruction includes “start-up”, “operation”, “deletion”, and “installation” of application 222.

In response to the instruction, application management portion 231 inputs identification information of application 222 (hereinafter referred to as “application identification information”) and a type of operation for application 222 (hereinafter referred to as an “operation type”) to application use frequency management portion 233. For example, application identification information includes an identification (ID) and a name of an application. An operation type includes “start-up”, “operation”, “deletion”, and “installation” of application 222.

Supervisory timer 240 inputs a time of start-up of application 222 to application use frequency management portion 233. Supervisory timer 240 inputs a time of installation of application 222 to application use frequency management portion 233.

Application use frequency management portion 233 has application use history DB 224 store the application identification information and the operation type input from application management portion 231. Application use frequency management portion 233 has application use history DB 224 store a time of start-up and a time of installation of application 222 input from supervisory timer 240.

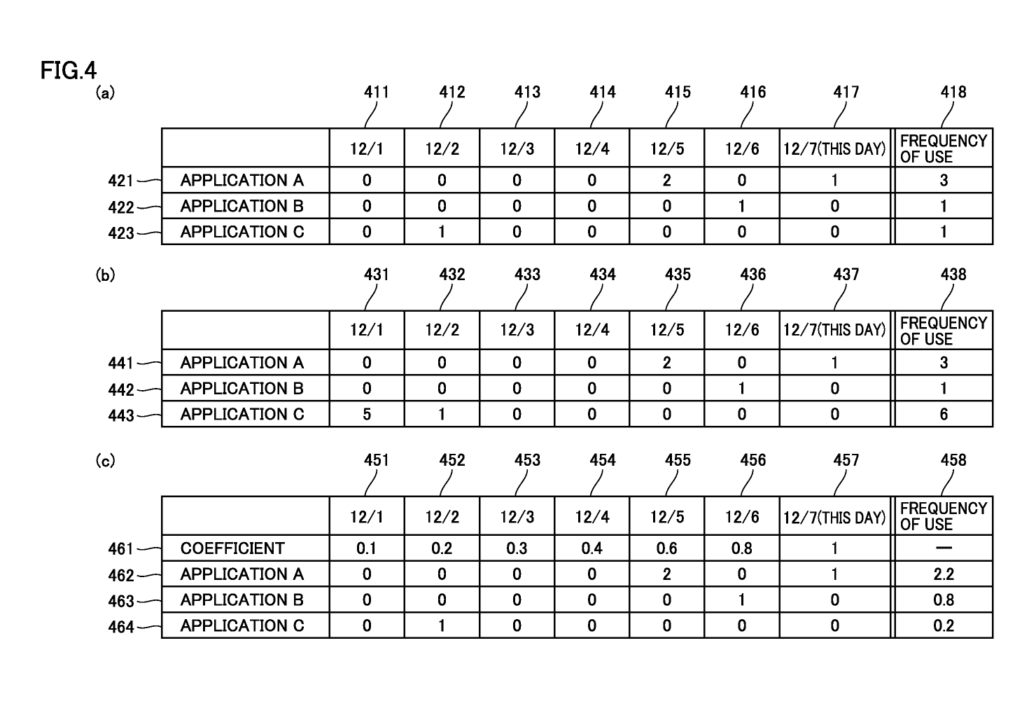

Application use frequency management portion 233 calculates a frequency of use of application 222 for each type of an application based on application use history DB 224. A method of calculating a frequency of use will be described in detail with reference to FIG. 4.

Application use frequency management portion 233 calculates a frequency of use every certain time period. For example, the certain time period is set at the time of design of portable terminal device 100. The certain time period may be configured to allow setting by a user. In one aspect, application use frequency management portion 233 calculates a frequency of use of application 222 at the time of start-up or installation of application 222.

Application use frequency management portion 233 determines whether or not to prohibit communication by application 222. For example, when a frequency of use of application 222 is lower than a predetermined frequency of use, application use frequency management portion 233 prohibits communication by application 222 (hereinafter referred to as a “communication prohibition state”). Application use frequency management portion 233 inputs a result of determination to communication control unit 239.

The predetermined frequency of use may be set at the time of design of portable terminal device 100. The predetermined frequency of use may be configured to allow setting by a user.

Display portion 201 displays a screen for operation of application 222. A display mode of display portion 201 includes a display mode in which luminance is not restricted and a display mode in which luminance is restricted (hereinafter referred to as a “panel saving mode”). For example, control unit 230 switches a display mode of display portion 201 to the panel saving mode when an operation onto portable terminal device 100 is not accepted for a certain period of time.

Panel-saving detection portion 235 detects change in display mode of display portion 201. Panel-saving detection portion 235 inputs a result of determination to application state management portion 237.

Operation portion 210 accepts an operation onto portable terminal device 100. Operation portion 210 inputs a signal in accordance with the detected operation to application state management portion 237. For example, operation portion 210 includes a touch panel. The touch panel may be any type of a resistive film type, a surface acoustic wave type, an infrared ray type, an electromagnetic induction type, and a capacitance type.

Application state management portion 237 determines whether or not a state of application 222 has been switched. A state of application 222 includes a state that application 222 is being used by a user (hereinafter referred to as a “foreground state”) and a state that application 222 is not being used by the user (hereinafter referred to as a “background state”). A result of determination by application state management portion 237 is input to communication control unit 239.

In one aspect, a state of application 222 is set to the foreground state when the user starts up application 222. A state of application 222 is set to the foreground state when the user resumes application 222 which has paused.

In another aspect, when the display mode of display portion 201 is set to the panel saving mode, a state of application 222 is set to the background state. When a signal for controlling application 222 is not detected for a certain period of time, a state of application 222 is set to the background state. When the screen for operation of application 222 is not displayed on display portion 201, a state of application 222 is set to the background state. When application 222 ends and when application 222 pauses, a state of application 222 is set to the background state.

Communication control unit 239 prohibits communication by application 222 with an information communication device based on a result of determination by application use frequency management portion 233 and a result of determination by application state management portion 237. For example, when application 222 is in the communication prohibition state and in the background state, communication control unit 239 prohibits communication by application 222.

In one aspect, communication control unit 239 prohibits communication by application 222 based on a result of determination by any one of application use frequency management portion 233 and application state management portion 237. In another aspect, such a configuration as allowing communication by application 222 set by a user may be employed.

<Data Structure>

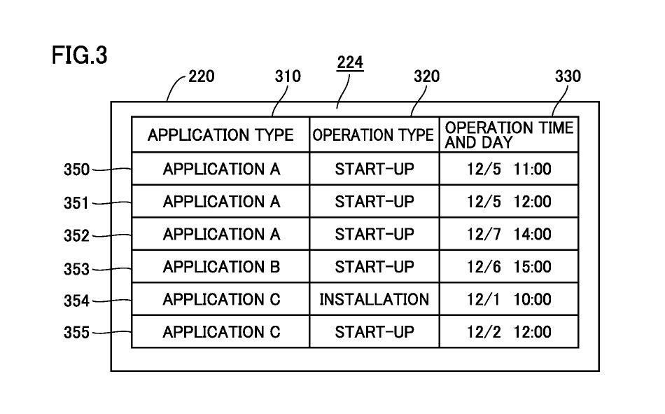

A data structure of application use history DB 224 will be described with reference to FIG. 3. FIG. 3 is a diagram representing application use history DB 224 stored in storage portion 220.

Storage portion 220 stores application use history DB 224. Application use history DB 224 includes an application type 310, an operation type 320, and an operation time and day.

For example, operation type 320 is either “start-up” or “installation” of application 222. Operation time and day 330 expresses a time of start-up of application 222 or a time of installation of application 222.

An application A was started up at eleven on December 5, as shown in a row 350. Application A was started up at twelve on December 5, as shown in a row 351. Furthermore, application A was started up at fourteen on December 7, as shown in a row 352. An application B was started up at fifteen on December 6, as shown in a row 353. An application C was installed at ten on December 1, as shown in a row 354. Application C was started up at twelve on December 2, as shown in a row 355.

In one aspect, operation time and day 330 may express any time between start-up of application 222 and end thereof. Alternatively, operation time and day 330 may express a time period from start-up of application 222 until end thereof.

In one aspect, operation time and day 330 expresses any time from start of installation of application 222 until end thereof. Alternatively, operation time and day 330 may express a time period from start of installation of application 222 until end thereof.

Application use frequency management portion 233 has application use history DB 224 store application type 310, operation type 320, and operation time and day 330 when application 222 is started up or installed.

<Frequency of Use>

A method of calculating a frequency of use of application 222 will be described with reference to FIG. 4. FIG. 4 shows methods (a) to (c) as methods of calculating a frequency of use of application 222 in one aspect.

Application use frequency management portion 233 calculates a frequency of use of application 222 for a certain period by referring to application use history DB 224. For example, with reference to the method (a) in FIG. 4, application use frequency management portion 233 calculates a frequency of use 418 based on the number of times of start-up from December 1 (a column 411) until December 7 (this day) (a column 417). In the method (a) in FIG. 4, application use frequency management portion 233 calculates the number of times of start-up for each day, however, limitation to each day is not intended.

As shown in a row 421, application A was started up twice on December 5 (a column 415) and started up once on December 7 (column 417). Therefore, frequency of use 418 of application A is calculated as 3 (=2+1).

As shown in a row 422, application B was started up once on December 6 (a column 416). Therefore, frequency of use 418 of application B is 1.

As shown in a row 423, application C was started up once on December 2 (a column 412). Therefore, frequency of use 418 of application C is 1.

When the frequency of use is lower than a predetermined frequency (hereinafter referred to as a “frequency-of-use threshold value”), communication control unit 239 prohibits communication by application 222. For example, when the frequency-of-use threshold value is set to 2, communication by applications B and C is prohibited.

In another aspect, with reference to the method (b) in FIG. 4, application use frequency management portion 233 calculates frequency of use 418 based on the number of times of start-up from December 1 (a column 431) until December 7 (this day) (a column 437) and the time and day of installation.

For example, at the time of installation of application 222, a certain number of times of use is added to a frequency of use. For example, when application C is installed on December 1, 5 is added to the frequency of use on December 1 (column 431). Therefore, a frequency of use 438 of application A is calculated as 6 (=1+5). For example, when the frequency-of-use threshold value is set to 5, communication by applications A and B is prohibited.

The added number of times of use is set at the time of design of portable terminal device 100. The added number of times may be configured to allow change by a user.

In general, installation of an application represents a user's intention to use the application. With the method (b), a frequency of use of an application installed during a certain period in the past is high. Since communication by the application is thus permitted, user's operability is not impaired.

In yet another aspect, application use frequency management portion 233 permits communication by an application started up at timing close to calculation of a frequency of use. Application use frequency management portion 233 prohibits communication by an application not started up at timing close to calculation of a frequency of use.

More specifically, as shown in a row 461 in connection with the method (c) in FIG. 4, a coefficient is set for each date. The coefficient is set to be greater as the date is closer to December 7 (this day) (a column 457).

For example, a coefficient for December 1 (a column 451) is set to 0.1. A coefficient for December 2 (a column 452) is set to 0.2. A coefficient for December 3 (a column 453) is set to 0.3. A coefficient for December 4 (column 451) is set to 0.4. A coefficient for December 5 (a column 455) is set to 0.6. A coefficient for December 6 (a column 456) is set to 0.8. A coefficient for December 7 (column 451) is set to 1.

A frequency of use of application 222 is calculated by multiplying the number of times of start-up by a coefficient. As shown in row 461, frequency of use 418 of application A is calculated as 2.2 (=2×0.6+1×1). As shown in a row 463, frequency of use 418 of application B is calculated as 0.8 (=1×0.8). As shown in a row 464, frequency of use 418 of application C is calculated as 0.2 (=1×0.2). When the frequency-of-use threshold value is set to 0.5, communication by application C is prohibited.

Thus, since an application started up at timing closer to calculation of the frequency of use is higher in frequency of use, communication by the application used temporally close is permitted. Communication by an application not used at timing close to calculation of the frequency of use is prohibited. Therefore, power consumption can be suppressed without impairing convenience of a user.

The coefficient is set at the time of design of portable terminal device 100. The coefficient may be configured to allow change by a user. The coefficient is not limited as above.

<Control Structure>

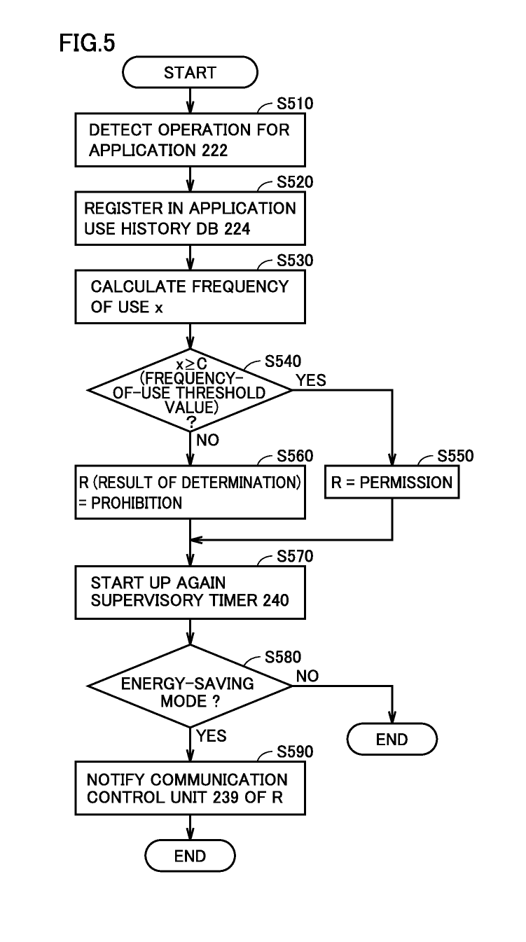

A control structure of portable terminal device 100 will be described with reference to FIG. 5. FIG. 5 is a flowchart representing a part of processing performed by CPU 20 of portable terminal device 100 in one aspect. The processing in FIG. 5 is implemented by execution of a program by CPU 20. In another aspect, a part or the entirety of the processing may be performed by a circuit element or other hardware.

In step S510, CPU 20 as application management portion 231 detects an operation for application 222.

In step S520, CPU 20 as application use frequency management portion 233 registers a type of application 222, an operation type, and a start-up time in application use history DB 224.

In step S530, CPU 20 as application use frequency management portion 233 calculates a frequency of use x of application 222.

In step S540, CPU 20 as application use frequency management portion 233 determines whether or not frequency of use x is equal to or greater than a frequency-of-use threshold value C. When CPU 20 determines that frequency of use x is equal to or greater than frequency-of-use threshold value C (YES in step S540), it switches control to step S550. Otherwise (NO in step S540), CPU 20 switches control to step S560.

In step S550, CPU 20 sets a result of determination R to “permission”.

In step S560, CPU 20 sets result of determination R to “prohibition”.

In step S570, CPU 20 starts up again supervisory timer 240.

In step S580, CPU 20 determines whether or not portable terminal device 100 is in an energy-saving mode. Step S580 may be skipped. Alternatively, step S580 may be performed at other timing, for example, before step S510. When CPU 20 determines that the portable terminal device is in the energy-saving mode (YES in step S580, it switches control to step S590. Otherwise (NO in step S580), CPU 20 has the process end.

In step S590, CPU 20 as application use frequency management portion 233 notifies communication control unit 239 of result of determination R. Thereafter, CPU 20 has the process end.

As above, portable terminal device 100 in one aspect can permit communication by an application high in frequency of use and prohibit communication by an application low in frequency of use. Thus, power consumption in portable terminal device 100 can be suppressed without impairing convenience of a user.

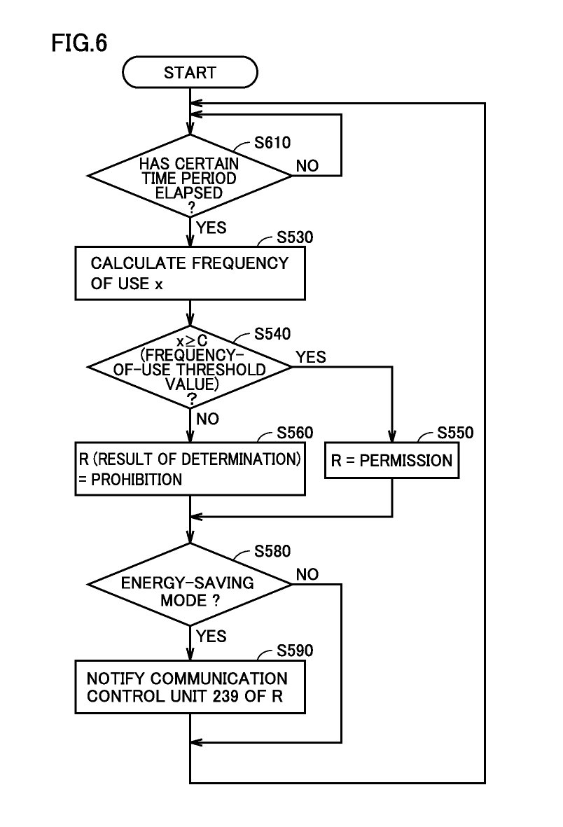

Another aspect will be described below. A control structure of portable terminal device 100 in another aspect will be described with reference to FIG. 6. FIG. 6 is a flowchart representing a part of processing performed by CPU 20 of portable terminal device 100 in another aspect. The processing in FIG. 6 is different from the flowchart in FIG. 5 in that the CPU performs step S610 and step S570 is skipped. The processing is otherwise the same. Therefore, description of steps the same as the steps illustrated in FIG. 5 will not be repeated.

The processing in FIG. 6 is implemented by execution of a program by CPU 20. In another aspect, a part or the entirety of the processing may be performed by a circuit element or other hardware.

CPU 20 calculates a frequency of use of application 222 every certain time period. Specifically, in step S610, CPU 20 as application use frequency management portion 233 determines whether or not a certain period of time has elapsed since start of count of time by supervisory timer 240. When CPU 20 determines that the certain period of time has elapsed (YES in step S610), it switches control to step S530. Otherwise (NO in step S610), CPU 20 switches control to step S610.

When frequency of use x calculated in S530 is lower than the predetermined frequency of use, application use frequency management portion 233 prohibits communication by application 222.

As above, portable terminal device 100 in another aspect can automatically switch between permission and prohibition of communication by an application every certain time period, and convenience of a user can be improved.

<Control Structure>

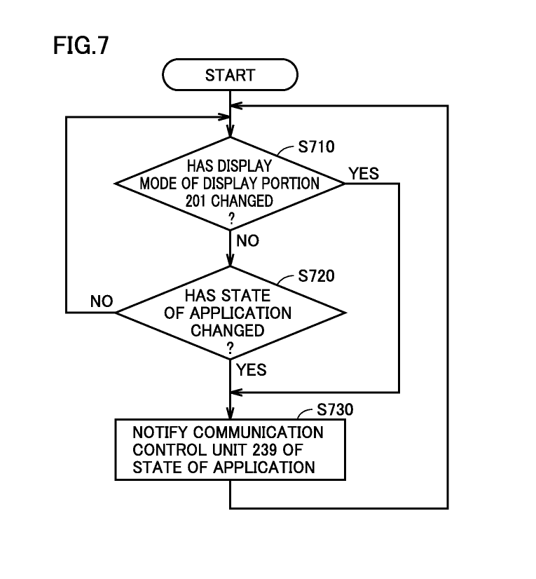

Yet another aspect will be described below. A control structure of portable terminal device 100 in another aspect will be described with reference to FIG. 7. FIG. 7 is a flowchart representing a part of processing performed by CPU 20 of portable terminal device 100 in another aspect. The processing in FIG. 7 is implemented by execution of a program by CPU 20. In another aspect, a part or the entirety of the processing may be performed by a circuit element or other hardware.

In step S710, CPU 20 determines whether or not the display mode of display portion 201 has changed, based on a result of determination by panel-saving detection portion 235. When the display mode has changed (YES in step S710), CPU 20 switches control to step S730. Otherwise (NO in step S710), CPU 20 switches control to step S720.

In step S720, CPU 20 determines whether or not a state of application 222 has changed, based on a result of determination by application state management portion 237. When CPU 20 determines in step S720 that the state of application 222 has changed (YES in step S720), it switches control to step S730. Otherwise (NO in step S720), CPU 20 has control return to step S710.

In step S730, CPU 20 as application state management portion 237 notifies communication control unit 239 of a state of application 222.

Communication control unit 239 prohibits communication by application 222 based on the state of application 222.

As above, portable terminal device 100 in another aspect can prohibit communication by an application in the background state. Portable terminal device 100 according to the present embodiment can permit communication by an application in the foreground state. Therefore, communication by an application being used by a user is carried out but communication by an application not being used by the user is not carried out. Power consumption can thus be suppressed without impairing convenience of a user.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

100 portable terminal device; 110 automatic transaction device; 120 network; 20 CPU; 23 antenna; 24 communication device; 25 user interface; 26 camera; 27 flash memory; 28 RAM; 29 ROM; 30 memory card drive device; 31 memory card; 32 microphone; 33 speaker; 34 audio signal processing circuit; 35 display; 36 LED; 37 data communication I/F; 38 vibrator; 39 timer; 201 display portion; 210 operation portion; 220 storage portion; 222 application; 224 application use history DB; 230 control unit; 231 application management portion; 233 application use frequency management portion; 235 panel-saving detection portion; 237 application state management portion; 239 communication control unit; 240 supervisory timer; 250 communication portion; 310 application type; 320 operation type; 330 operation time and day; and 418 frequency of use.

1. A portable terminal device, comprising:
a storage portion for storing an application and a history of use of said application;
a communication portion for communicating with an information communication device; and
a control unit for controlling said portable terminal device, said control unit being configured to
calculate a frequency of use of said application based on said history of use, and
prohibit communication by said application with said information communication device when said frequency of use is lower than a predetermined frequency of use.

2. The portable terminal device according to claim 1, wherein
said storage portion further stores an installation time at which said application was installed, and
said control unit is configured to calculate said frequency of use based on said history of use and a time when said application was installed.

3. The portable terminal device according to claim 1, wherein
said control unit is configured to calculate said frequency of use of said application every certain time period.

4. The portable terminal device according to claim 1, wherein
said control unit is configured to
detect a signal for controlling said application, and
prohibit communication by said application with said information communication device when said signal is not detected for a certain time period.

5. The portable terminal device according to claim 1, further comprising a display portion for displaying a screen for execution of said application, wherein
said control unit is configured to prohibit communication by said application with said information communication device when said screen for execution of said application is not displayed on said display portion.
